(19) United States
(12) Patent Application Publication
(10) Pub. No.: US 2015/0381972 A1
(43) Pub. Date: Dec. 31, 2015

(54) DEPTH ESTIMATION USING MULTI-VIEW STEREO AND A CALIBRATED PROJECTOR

(71) Applicant: Microsoft Corporation, Redmond, WA (US)

(72) Inventors: Adarsh Prakash Murthy Kowdle, Redmond, WA (US); Richard S. Szeliski, Bellevue, WA (US)

(21) Appl. No.: 14/319,641

(22) Filed: Jun. 30, 2014

(51) Int. Cl. H04N 13/04; H04N 17/00; G06T 7/00; H04N 9/31

(52) U.S. Cl. CPC H04N 13/0425; H04N 9/3191; H04N 17/004; G06T 7/002

(57) ABSTRACT

The subject disclosure is directed towards using a known projection pattern to make stereo (or other camera-based) depth detection more robust. Dots are detected in captured images and compared to the known projection pattern at different depths, to determine a matching confidence score at each depth. The confidence scores may be used as a basis for determining a depth at each dot location, which may be at sub-pixel resolution. The confidence scores also may be used as a basis for weights or the like for interpolating pixel depths to find depth values for pixels in between the pixels that correspond to the dot locations.

### BACKGROUND

Camera based depth-sensing is directed towards projecting a light pattern onto a scene and then using image processing to estimate a depth for each pixel in the scene. For example, in stereo depth-sensing systems, depth sensing is typically accomplished by projecting a light pattern (which may be random) onto a scene to provide texture, and having two stereo cameras capture two images from different viewpoints. Then, for example, one way to perform depth estimation with a stereo pair of images is to find correspondences of local patches between the images. Once matched, the projected patterns within the images may be correlated with one another, and disparities between one or more features of the correlated dots used to estimate a depth to that particular dot pair.

Instead of using two cameras, if a known light pattern is projected onto a scene, the known pattern along with the image obtained a single camera may be used to estimate depth. In general, the camera image is processed to look for disparities relative to the known pattern, which are indicative of the depth of objects in the scene.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter

Briefly, one or more of various aspects of the subject matter described herein are directed towards estimating depth data for each of a plurality of pixels, including processing images that each capture a scene illuminated with projected dots to determine dot locations in the images. For each dot location, confidence scores that represent how well dot-related data match known projected dot pattern data at different depths are determined and used estimate the depth data.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components that may be configured to project and capture a light pattern for determining depth via matching with known projected pattern data, according to one or more example implementations.

FIGS. 2 and 3 are representation of an example of projecting dots into scene a scene for determining depth by matching captured image data with known projected pattern data, according to one or more example implementations.

FIG. 4 is a flow diagram representing example steps that are used in determining a depth map based upon known projected pattern data, according to one or more example implementations.

FIG. 5 is a representation of how projected dots may be used to determine dot peak locations at sub-pixel resolution, according to one or more example implementations.

FIG. 6 is a representation of how dot-related data may be compressed into a data structure, according to one or more example implementations.

FIG. 7 is a flow diagram representing example steps that may be taken to determine dot peak locations, according to one or more example implementations.

FIG. 8 is a representation of how dots resulting from a projected ray may be used in matching expected dot locations with known projected dot pattern positions to determine depth data, according to one or more example implementations.

FIG. 9 is a flow diagram representing example steps that may be taken to evaluate each image-captured dot against each projected dot to determine matching (confidence) scores at different depths, according to one or more example implementations.

FIG. 10 is a flow diagram representing example steps that may be taken determine whether dot peaks are close enough to be considered a match, according to one or more example implementations.

FIG. 11 is a representation of how depth computations may be robust to semi-occluded images, according to one or more example implementations.

FIG. 12 is a representation of how interpolation may be based upon confidence scores at different depths, according to one or more example implementations.

FIG. 13 is a block diagram representing an exemplary non-limiting computing system or operating environment, in the form of a gaming system, into which one or more aspects of various embodiments described herein can be implemented.

### DETAILED DESCRIPTION

Various aspects of the technology described herein are generally directed towards having a known light pattern projected into a scene, and using image processing on captured images and the known pattern to provide generally more accurate and reliable depth estimation (relative to other techniques). The technology also leverages one or more various techniques described herein, such as enumerating over dots rather than pixels, trinocular (or more than three-way) matching, the use of sub-pixel resolution, and confidence-based interpolation. The light pattern may be a fixed structure known in advance, e.g., calibrated at manufacturing time, or learned in a user-performed calibration operation, regardless of whether the light pattern is generated in a planned pattern or a random (but unchanged thereafter) pattern.

In one aspect, two or more cameras are used to capture images of a scene. For example, with left and right stereo cameras, the two captured images along with the known light pattern may be used with a three-way matching technique to determine disparities that are indicative of depth. In other words, the known pattern, the left image and the right image may be used to estimate a depth based upon the disparity of each projected/captured dot. Having multiple cameras viewing the scene helps overcome uncertainties in the depth estimation and helps reduce mismatches. In addition, the technique is robust to the failure of a camera and continues to estimate depth (although typically less reliably) as long as at least one camera is viewing the scene and its position with respect to the projector is known.

A dot detection process may be used, including one that estimates the positions of the dots to sub-pixel accuracy, giving more accurate sub-pixel disparities. This provides for more accurate matching and avoids discretizing the disparities.

Interpolation may be used in which computed match scores (e.g., each corresponding to confidence of the estimated depth for a pixel) are used to compute a depth for pixels that did not have a dot-based depth estimated for them. For example, the confidence at each depth may be used as weights in the interpolation computation. This, along with possibly other data such as edge-based data based upon a color (e.g., RGB) image and/or a clean IR image serves as a guide for the interpolation.

It should be understood that any of the examples herein are non-limiting. For example, the projected light pattern generally exemplified herein comprises generally circular dots, but projected dots may be of any shape; (although two-dimensional projected shapes such as dots tend to facilitate more accurate matching than one-dimensional projections such as stripes). As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in depth sensing and image processing in general.

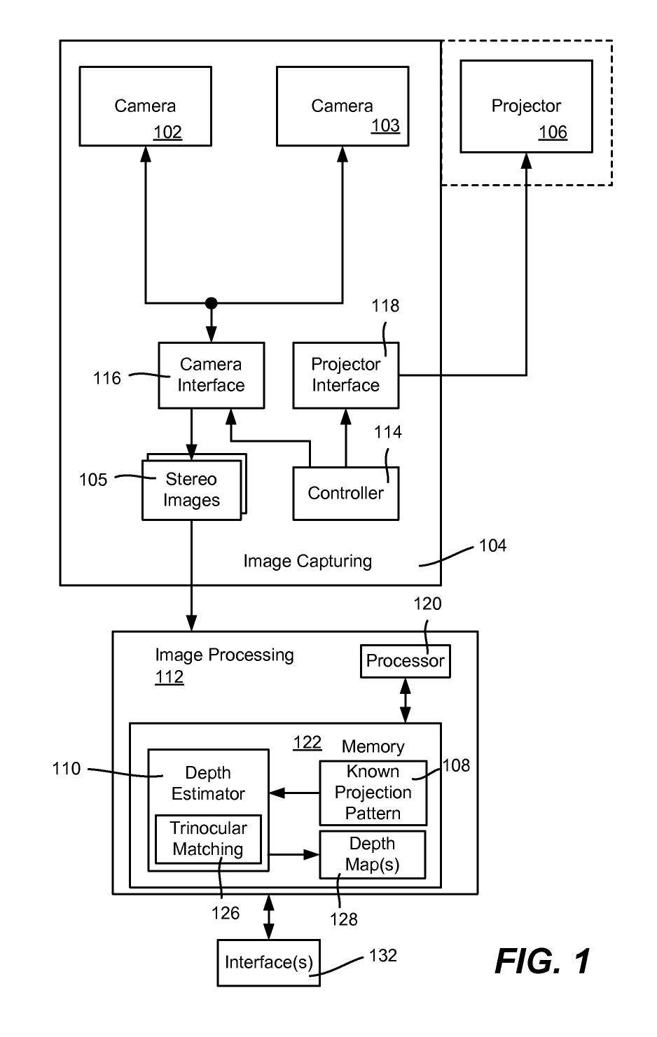

FIG. 1 shows an example system in which stereo cameras 102 and 103 of an image capturing system or subsystem 104 capture left and right stereo images 105 synchronized in time (e.g., the cameras are “genlocked”). In one implementation the cameras 102 and 103 capture infrared (IR) images, as IR does not affect the visible appearance of the scene (which is generally advantageous, such as in video conferencing and object modeling applications). As can be readily appreciated, in some scenarios such as studio environments, more than two IR depth-sensing cameras may be present. Further, one or more other cameras may be present in a given system, such as RGB cameras, and such other cameras may be used to help in estimating depth, for example.

In FIG. 1, a projector 106 is shown that projects an IR pattern onto a scene, such as a pattern of dots, although other spot shapes and/or pattern types may be used. For purposes of brevity, dots are generally described hereinafter. The pattern may be designed (e.g., encoded) into a diffractive optical component (a diffractive optical element or combination of elements) that disperse laser light into the scene, e.g., as a dot pattern. As set forth above, the pattern may be planned or random, but is learned by calibration.

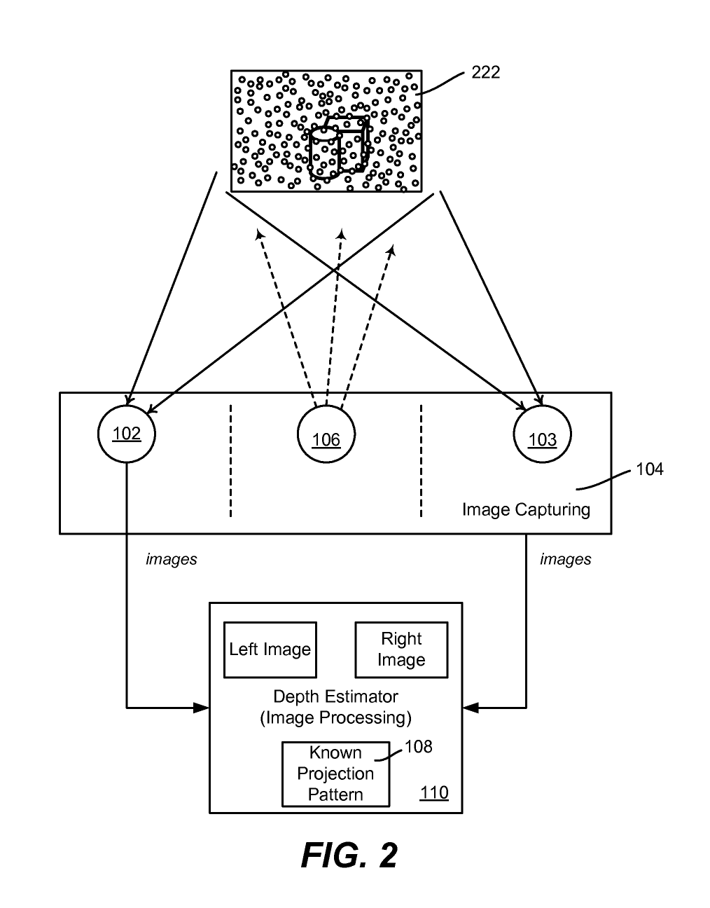

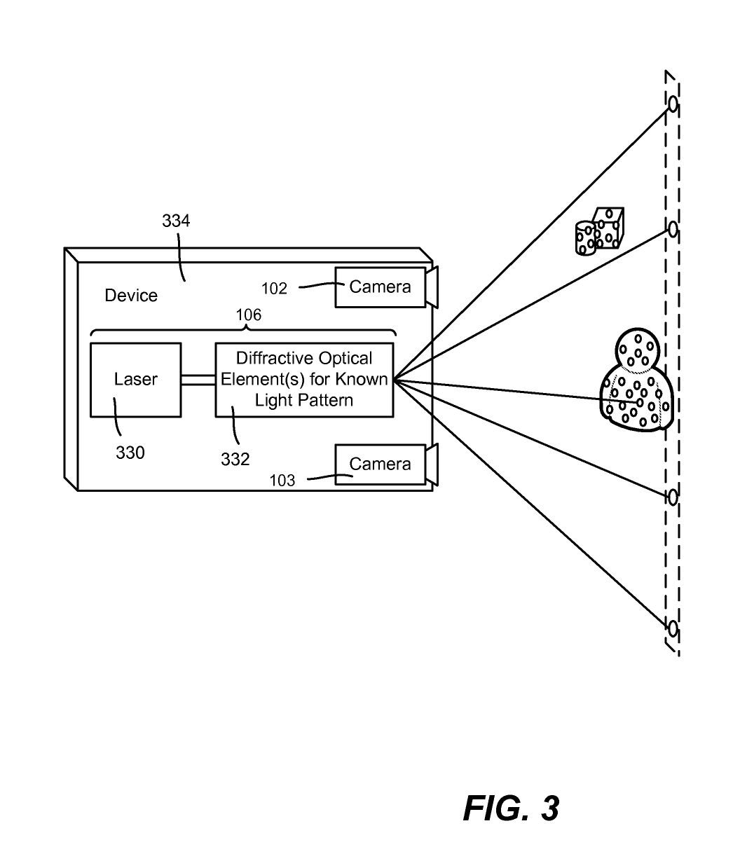

FIGS. 2 and 3 exemplify the projection concept. The projector 106, represented in FIG. 2 as a circle in between the stereo cameras 102 and 103, and in FIG. 3 as a laser 330 coupled to a diffractive optical element 332 incorporated into a device 334, projects a dot pattern onto a scene 222 (FIG. 2). Via calibration, the projected dot pattern 108 is known to a depth estimator 110, which may be part of an image processing system or subsystem 112. The known dot pattern may be maintained in any suitable data structure, and in one implementation tracks at least the (x, y) coordinate, (which may be at a sub-pixel resolution as described below), of each dot at various possible depths; this corresponds to storing the projected ray of each dot. An alternative is to represent each dot as a bit vector including neighbors for vector matching with camera-captured dots similarly represented by vectors.

The cameras 102 and 103 capture the dots as they reflect off of object surfaces in the scene 222 and (possibly) the background. In general, one or more features of the captured dots are indicative of the distance to the reflective surface. Note that FIGS. 2 and 3 (or any of the drawings herein) are not intended to be to scale, nor represent the same scene as one another, nor convey any sizes, distance, dot distribution pattern, dot density and so on.

Note that the placement of the projector 106 may be outside the cameras (e.g., FIG. 1), or in between the cameras (FIGS. 2 and 3) or at another location, such as above or below one or both of the cameras. The examples herein are in no way limiting of where the cameras and/or projector are located relative to one another, and similarly, the cameras may be positioned at different positions relative to each other. Notwithstanding, the relative locations of the cameras and projector are known, e.g., as determined at manufacturing time and/or able to be re-measured if needed.

By illuminating the scene with a relatively large number of distributed infrared dots, e.g., typically on the order of hundreds of thousands, the cameras 102 and 103 capture texture data as part of the infrared image data for any objects in the scene. As described herein, to facilitate more accurate dot matching between left and right images, the dots in the images, along with the known dot pattern are processed.

In one implementation the example image capturing system or subsystem 104 includes a controller 114 that via a camera interface 116 controls the operation of the cameras 102 and 103. The exemplified controller 114, via a projector interface 118, also may control the operation of the projector 106. For example, the cameras 102 and 103 are synchronized (genlocked) to capture stereo images at the same time, such as by a controller signal (or different signals for each camera). The projector 106 may be turned on or off, pulsed, and otherwise have one or more parameters controllably varied, for example.

The images 105 captured by the cameras 102 and 103 are provided to the image processing system or subsystem 112. In some implementations, the image processing system 112 and image capturing system or subsystem 104, or parts thereof, may be combined into a single device. For example a home entertainment device may include all of the components shown in FIG. 1 (as well as others not shown). In other implementations, parts (or all) of the image capturing system or subsystem 104, such as the cameras and projector, may be in a separate device that couples to a gaming console, personal computer, mobile device, dedicated processing device and/or the like. Indeed, a gaming console is exemplified below as one environment that may be used for processing images into depth data.

The image processing system or subsystem 112 includes a processor 120 and a memory 122 containing one or more image processing components, such as the depth estimator 110. In one aspect, the depth estimator 110 includes a trinocular matching component 126 or the like that uses the images as well as the known projector pattern 106 to estimate depth data. One or more depth maps 128 may be obtained via the depth estimator 110 as described herein.

Also shown in FIG. 1 is an interface 132 to the image processing system or subsystem 118, such as for connecting a computer program, keyboard, game controller, display, pointing device, microphone for speech commands and/or the like as appropriate for a user to interact with an application or the like that uses the depth map.

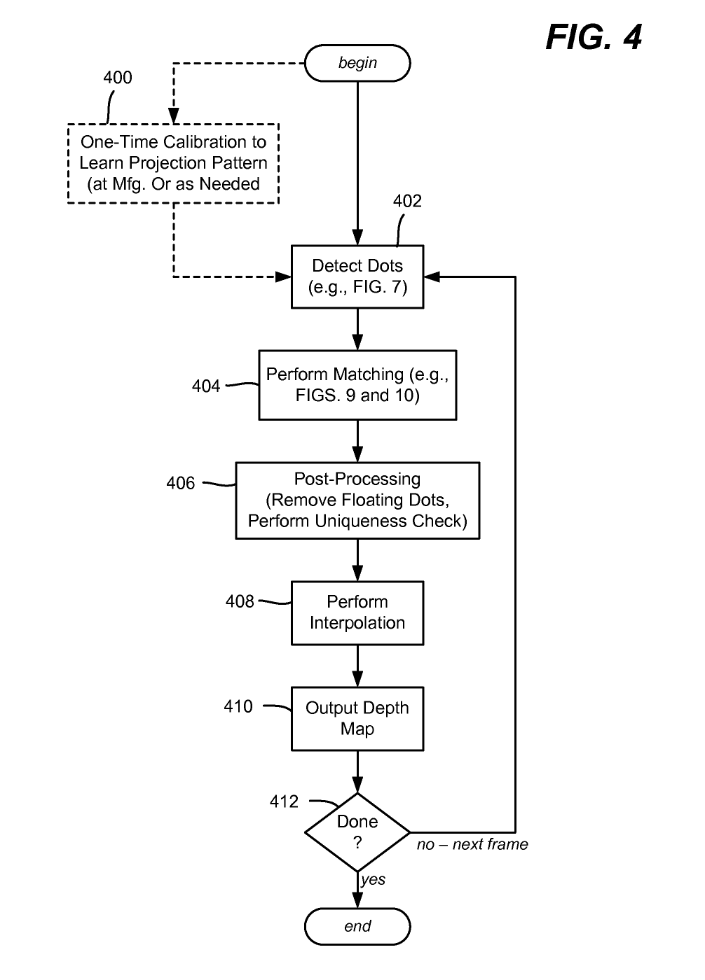

FIG. 4 is a generalized flow diagram showing example steps of one overall process, including a one-time calibration process at step 400, such as at a time of manufacturing the device; (it is possible that calibration may be repeated by the device owner or by sending the device for service, such as if shipping, heat or other environmental factors cause drift.

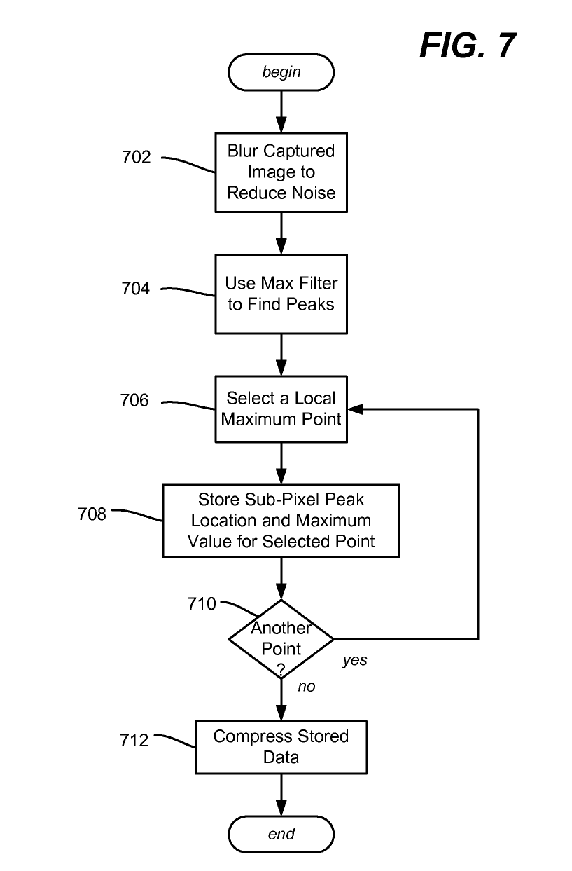

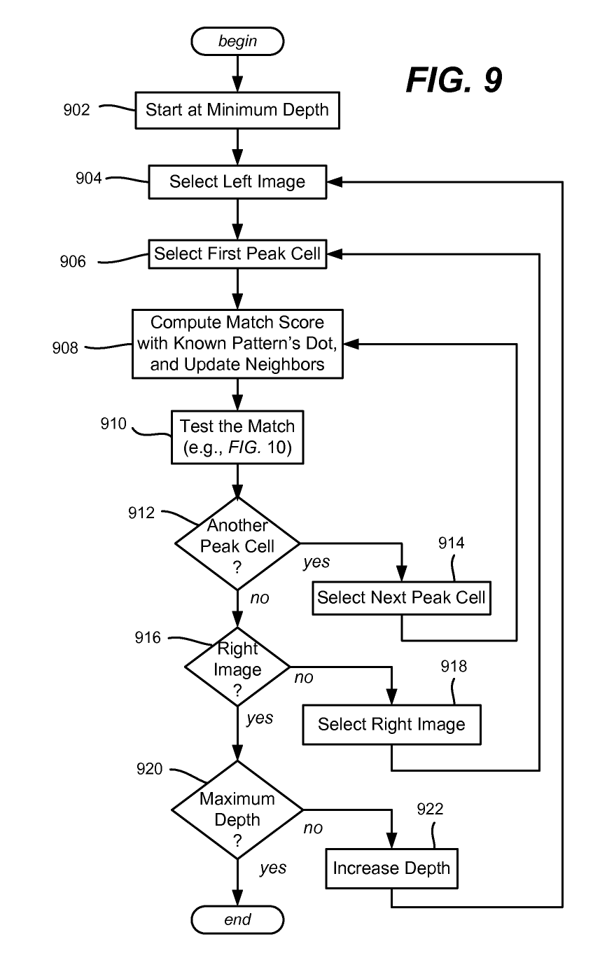

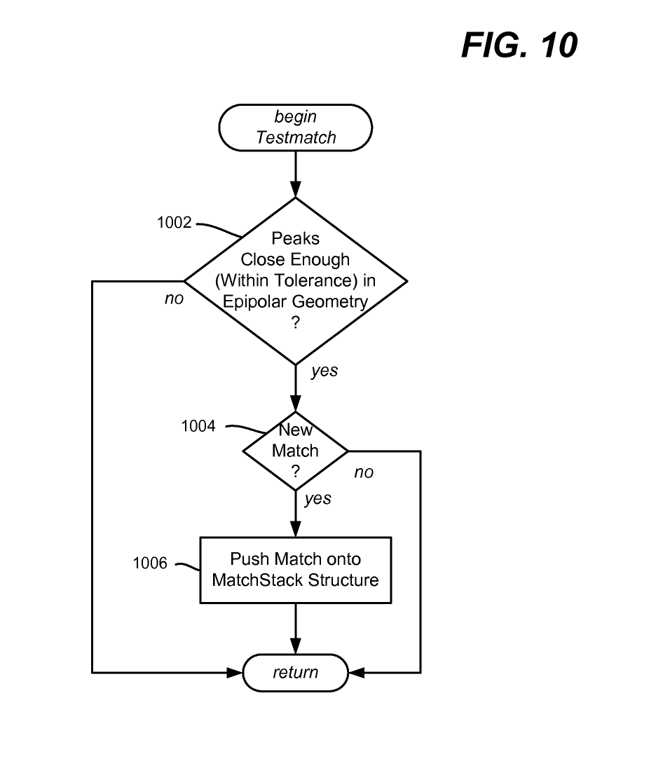

The example steps used in depth map generation are described in further detail below, and in general, include a dot detection process in which the positions of the camera-captured dots are located and stored, as represented by step 402 (and with reference to FIG. 7). Data representative of the camera-captured dots are matched against data representative of the known projected dots, as generally represented at step 404 (and with reference to FIGS. 9 and 10).

After matching, some post-processing may be performed at step 406, which in general cleans up anomalies. Interpolation is performed at step 408 in order to determine depth values for pixels that do not have a direct dot-based estimated depth value, e.g., for pixels in between dots. Interpolation may be based on confidence scores of nearby pixels that have direct dot-based estimated depth values, as well as on other techniques such as edge detection that factors in whether a depth is likely to change for a pixel because the pixel may be just beyond the edge of a foreground object.

After interpolation fills in the pixel depth values needed to complete the depth map, step 410 outputs the depth map. The process repeats at an appropriate frame rate via step 412, until frames of depth maps are no longer needed, e.g., the device is turned off, an application that wants frames of depth map is closed or changes modes, and so on.

With respect to dot detection, in general, the dots have a soft circularly symmetric profile similar to a Gaussian or blurred circle (although the exact shape does not significantly matter). In infrared images, each pixel that is illuminated by at least part of a dot has an associated intensity value. In one or more implementations, each input image is blurred, e.g., with a 1-2-1 filter used on each pixel (as known in image processing), which reduces noise. A next operation uses an s×s max filter (a sliding s×s window that finds the maximum intensity value in each window position, also well-known in image processing) on the image to compare each pixel to find pixels that are local maxima (or ties the maxima) within an s×s area. A suitable value for s is five (5).

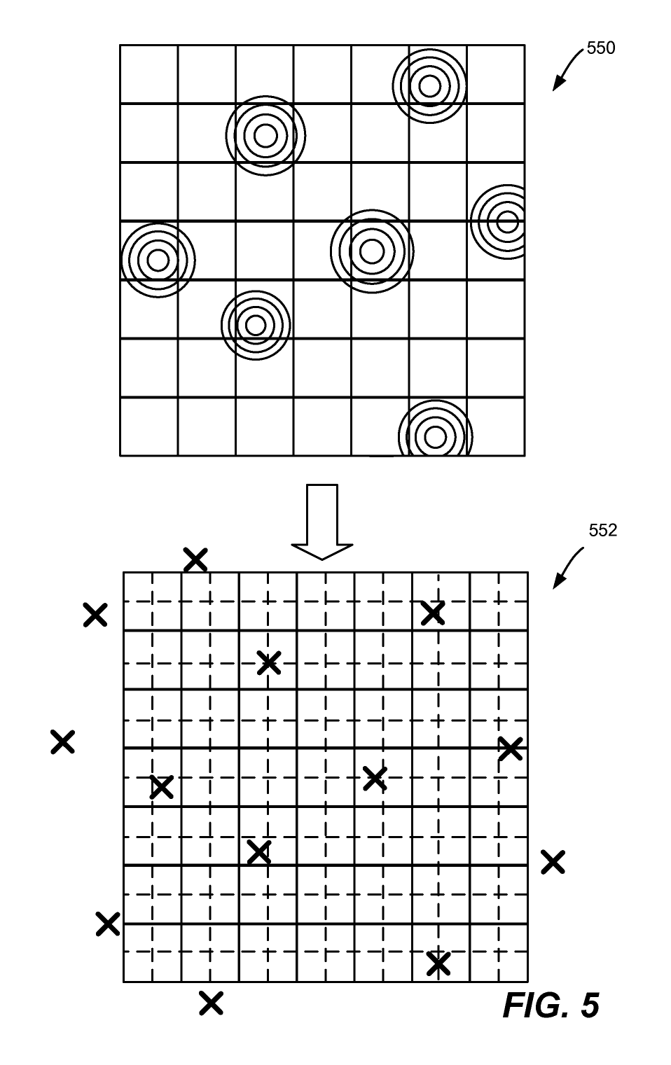

For every such local maximum point, a horizontal and vertical three-point parabolic fit to the intensities is used to find a sub-pixel peak location and maximum (e.g., interpolated) value at that location; (that is, interpolation may be used to adjust for when the peak is not centered in the sub-pixel). As can be seen in the pixels (represented as squares of a partial image 550 of FIG. 5), a feature for this dot pattern is the dot peak intensity location. This can be estimated to within sub-pixel accuracy. More particularly, as represented in FIG. 5, the X-shaped crosses in the finer grid representation 552 represent the estimated dot centers, with the pixels divided into sub-pixels by the dashed lines. Each estimated center corresponds to a sub-pixel. The centers of some additional dots outside the exemplified grid (e.g., the grid may be part of a larger image) are also shown.

Note that FIG. 5 subdivides the pixels into 2×2 sub-pixels to double the resolution. However instead of double sub-pixel resolution, even higher resolution may be obtained by subdividing the pixels further, e.g., into nine sub-pixels each, sixteen sub-pixels each and so on; (non-square subdivision may be used as well).

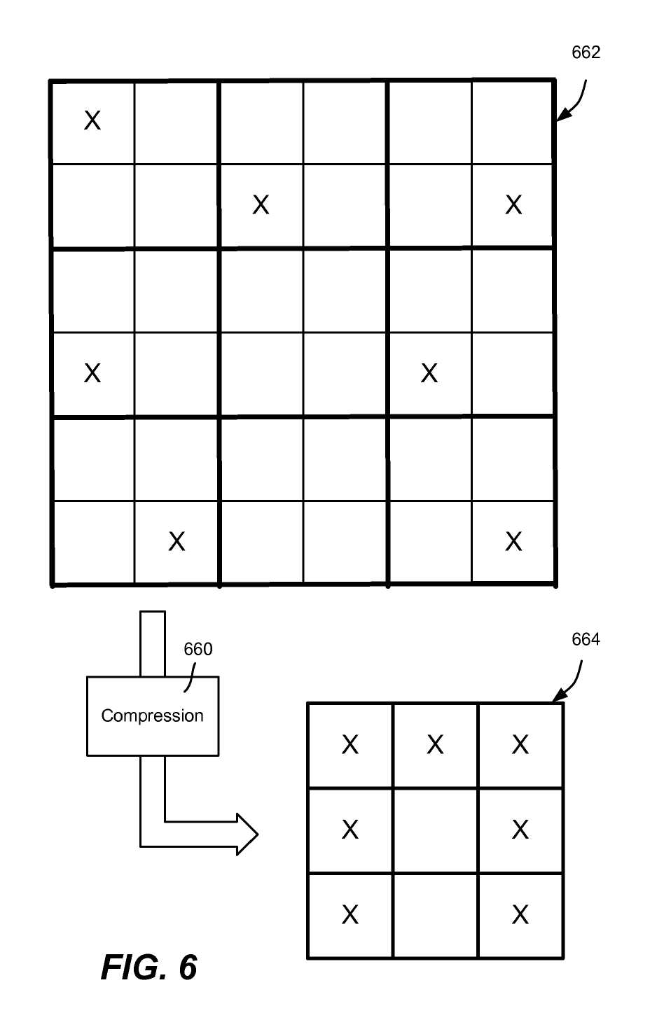

Data representing the detected peaks may be stored in a data structure that includes for each peak the sub-pixel location and the peak magnitude, and also provides additional space for accumulating information during dot matching, such as a matching score. In one or more implementations, by construction of the diffractive optical element, the peaks are not located any closer than d pixels apart, whereby a smaller data structure (storage image comprising an array of cells) may be used. More particularly, as represented in FIG. 6, in a compression operation 660, the data for each peak obtained from the image 662 may be put into a bin that is computed by dividing its true position by d and rounding to the nearest pixel, providing a compressed image structure 664. Note that the grid of cells in FIG. 6 is not representative of a sub-pixel grid as in FIG. 5, but rather represents a way to compress the needed size of the data structure by eliminating the need to reserve storage for many of the pixels that do not have a peak.

A suitable compression parameter is one that is large enough to remove as much space between dots (peaks) as possible, but small enough so that two distinct dots do not collide into the same cell. In the above example, a compression factor of two was used, as any pair of peaks is at least two pixels away from one another.

FIG. 7 summarizes an example dot detection process, beginning at step 702 where a captured image is blurred to reduce noise. Note that FIG. 7 is performed on each image, e.g., left and right, which may be performed in parallel, at least to an extent. Step 704 represents using a max filter to find the peaks.

For each peak, or local maximum point, steps 706, 708 and 710 store the representative information in the data structure, including the sub-pixel location of the peak, and the (e.g., interpolated) intensity value at that location. This fills the data structure, which as represented in FIG. 6, is typically sparse because of the design of the diffractive optical element. Step 712 compresses the data structure, as also shown and described with reference to FIG. 6.

Once the images have been processed to find the dot peaks and store them in the compressed data structure matching occurs. In one alternative, trinocular dot matching is used. Note that instead of processing each pixel, in one implementation, trinocular dot matching uses a plane sweep algorithm to estimate the disparity for each dot in the laser dot pattern. Because the projector pattern is known (computed and stored during a calibration operation), trinocular dot matching matches each dot in the known pattern with both the left and right image to estimate the per-dot disparity.

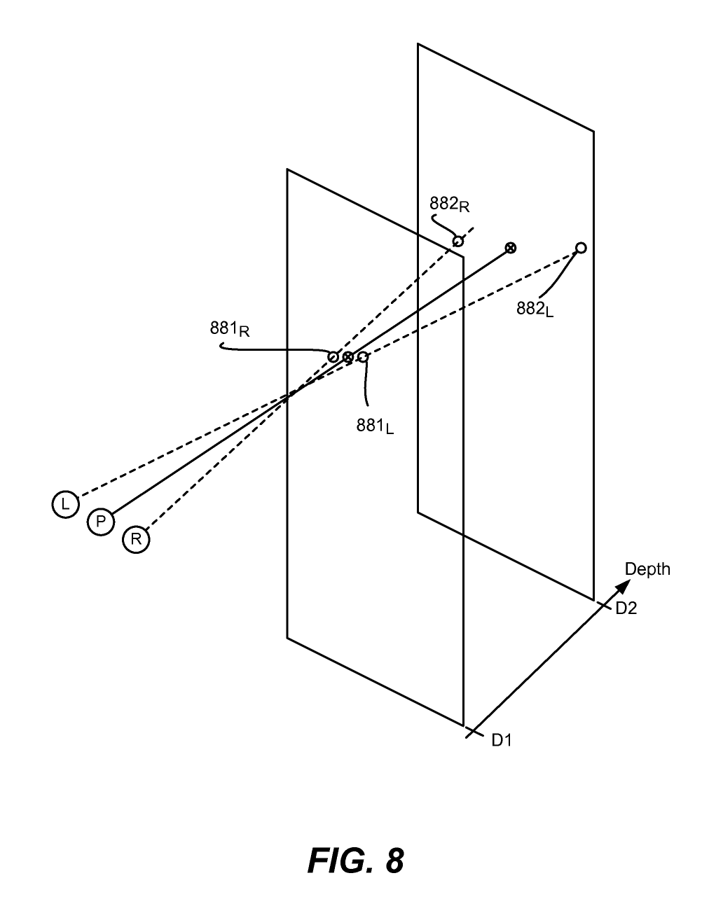

In general, for the known pattern, the dots' ray (x, y) positions at different depths may be pre-computed. As represented in FIG. 8, if the depth is at D1, then the left camera image should have a corresponding dot at (sub-pixel) 881L, and the right camera image should have a corresponding dot at (sub-pixel) 881R; if the depth is D2, these sub-pixel locations will have shifted to 882L and 882R, respectively. Each possible depth may be used, however in one or more implementations a sampling of some of the depths may be used. For example, a depth change that moves about one pixel may be used, in which the depth change may be related to the inverse depth.

For a given depth and a dot location in the known pattern, each image is processed in a disparity sweep, including to determine whether it also has a dot at the expected corresponding position at that depth. For computational efficiency, the three-way matching may operate on a tile-by-tile basis (and tiles may be fattened so that 2D support can be properly aggregated), where each tile has its own disparity sweep performed.

In one implementation, the disparity sweep returns the winning match scores in a multi-band image, whose bands correspond to a MatchTriplet structure:

```
struct MatchPair
{
  float score; // matching score (# similar neighbors)
  float d; // estimated disparity
};
struct MatchStack
{
  MatchPair curr; // newest match being considered
  MatchPair prev; // previous match
  MatchPair best; // best match so far
};
struct MatchTriplet
{
  MatchStack left; // match in left image
  MatchStack right; // match in right image
  MatchPair both; // match in both images
};
```

As represented in FIG. 9, the disparity sweep has an outer iteration (steps 902, 920 and 922) over all the disparities specified by the disparity sweep range (dMin, dMax), which represent the minimum and maximum depths that are to be measured. The disparity sweep includes intermediate iterations over the left and right images (steps 904, 916 and 918), and inner iterations over the (x, y) peak cells in the tile (steps 906, 912 and 914).

In general, for the current depth, the inner loop at step 908 evaluates whether there is a match at the projected dot's location and the expected left dot location, and similarly whether there is a match at the projected dot's location and the expected right dot location. However, generally because of noise, even if there should be a match, there may not be one at the exact location, and thus neighbors/neighboring pixels or sub-pixels are also evaluated in one implementation.

In general, the more similar neighbors, the more confidence that there is a match. With respect to neighbors, to aggregate support spatially, the scores of neighbors with compatible disparities are increased, e.g., by calling an UpdateNeighbors routine. This operation disambiguates among potential matches, as the number of neighbors (within the neighbor distance of each peak) is the score on which winning match decisions may be based.

An alternative way (or additional way) to match dots with pattern data is by representing each captured dot as a vector and each known projected dot as vectors, in which the vectors include data for a dot's surrounding neighborhood (pixel or sub-pixel values). The vector representations for the known projection pattern of dots may be pre-computed and maintained in a lookup table or the like. The closest vector, e.g., evaluating the captured dot vector against a set of vectors at different depths, is given the highest confidence scores, the next closest the next highest score and so on to a lowest confidence score.

The vectors may be bit vectors, with each bit value indicating whether a dot exists or not for each surrounding position in a neighborhood. Then, for each dot in a captured image after computing its neighborhood bit vector, the distance (e.g., the Hamming distance) between the bit vectors may be used to find the closest match. Note that this may be efficiently done in low-cost hardware, for example. Further, this vector-based technique may be highly suited for certain applications, e.g., skeletal tracking.

In one or more implementations, at the deepest level within the disparity sweep stage is a TestMatch subroutine (e.g., FIG. 10) that tests whether two peaks are compatible. Peaks are compatible if they are close enough in epipolar geometry; (note that another test that may be used is to check whether the left and right peaks have similar magnitude). If the score (epipolar distance) is within a tolerance (tol) parameter (step 1002) and is a new match (step 1004), the NewMatch routine is used to push this match onto the MatchStack structure (step 1006). A suitable value for the tol parameter may be set to 1.5 pixels.

At the end of the matching stage, the MatchStack structure for each projector peak contains the winning match in its best field. The MatchTriplet has the winning match for the best match on the left image, best match on the right image and the best match on which both left and right agree together.

In actual practice, a small difference exists in the images captured by the left and right cameras, which results in neighboring peaks in some scenarios to merge to one dot at the time of detection. In an ideal scenario, the best match on the left image, best match on the right image and the best match that both left and right will all result in the same disparity; the best joint disparity is ideally be the best three-way matched disparity. However, noise, intensity values below the threshold and so forth can cause missing dots, which result in different disparities.

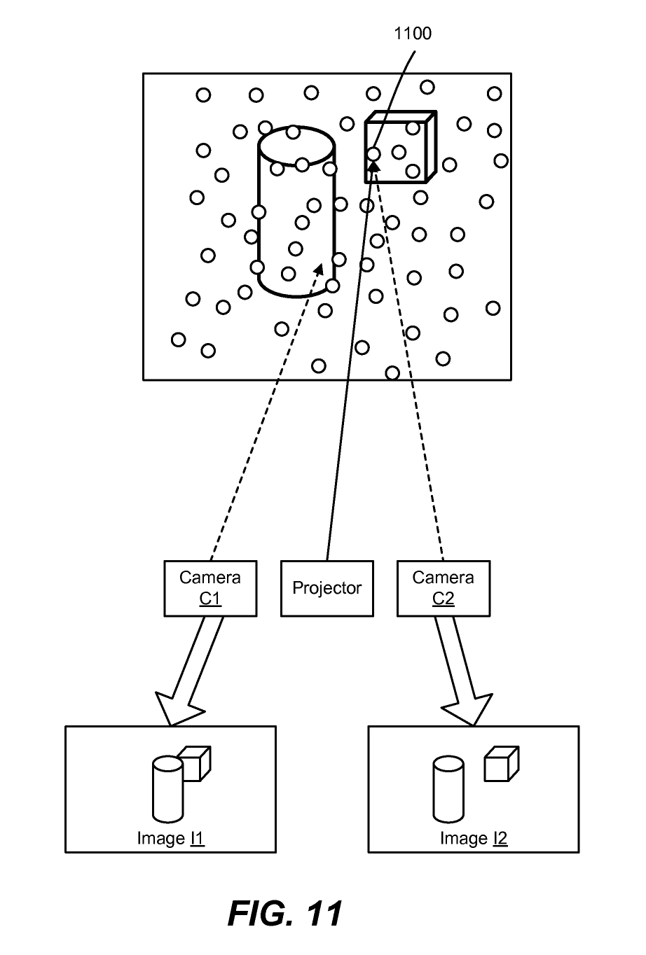

Further, semi-occlusion can prevent both cameras from seeing the same dot. Semi-occlusion is generally represented in FIG. 11, where the left camera C1 cannot capture in its corresponding image 11 the projected dot 1100, but the right camera C2 can in its image 12. Therefore, a robust decision may be used that allows a two-view match to be the final winner for determining a dot's depth even when a valid (but lower scoring) three-way match exists.

The final result typically has sparse errors due to confident-incorrect dot matches. These artifacts may be reduced by performing one or more post-processing steps. For example, one step may remove floating dots, comprising single outlier dots that have a significantly different disparity from the nearest dots in a 5×5 neighborhood. The mean and the standard deviation (sigma) of the disparities of the dots in the neighborhood may be used for this purpose, e.g., to remove the disparity assigned to the current pixel if it is different from the mean disparity by greater than three sigma.

Another post-processing step is to perform a uniqueness check. This checks with respect to the left and right depth data that there are no conflicting depths for a particular pixel. One implementation considers the (projected, left pixel) pair, and (projected, right) pair; when there is a clash in either of the pairs the lower scoring pixel is marked as invalid. An alternative three-way uniqueness check also may be used instead of or in addition to the two-way check.

Dot matching allows obtaining disparity-based depth estimates for the dots, resulting in a sparse disparity map. A next stage is an interpolation operation (an up-sampling stage) that starts with the sparse depth estimated at the dots and interpolates the missing data at the rest of the pixels, e.g., to provide a depth map with a depth value for every pixel. One interpolation process uses a push-pull interpolation technique guided by the matching score and/or by a guide image or images (e.g., a clean IR image without dots and/or an RGB image or images) to recover the dense depth of the scene. Distance of the pixel being (for which depth is being interpolated) to each of the dots being used is one way in which the interpolation is being weighted.

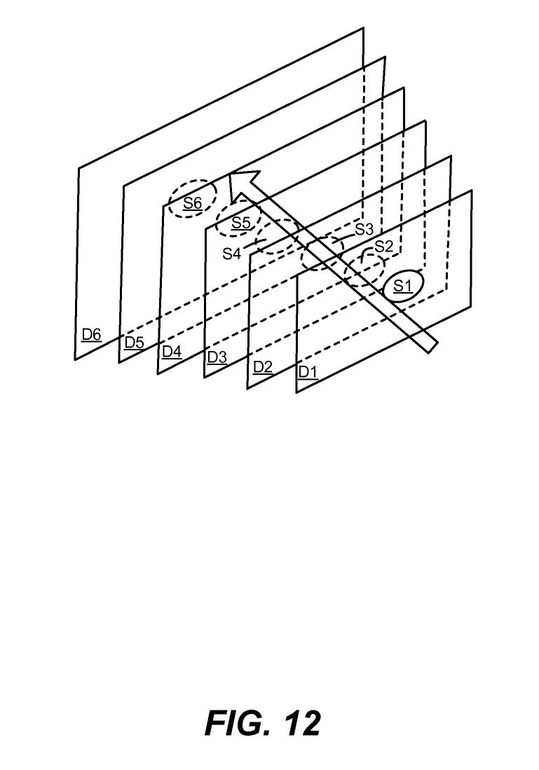

FIG. 12 represents the concept of using confidence scores (e.g., S1-S6) associated with detected dots. For example, for a given ray represented by the arrow in FIG. 12, the camera may have detected nearby dots, but one dot, represented by the score S3, is where it is expected to be in the captured image when comparing to the projected dot at depth D3 and thus has a higher confidence score. As described above, confidence scores may be computed by neighbor matches (e.g., the number of neighbors summed) or via vector bitmap similarity (e.g., inversely proportional to the Hamming distance), or via another matching technique. In interpolation for determining depth values for nearby pixels, more weight is given to this depth.

Thus, the up-sampling stage propagates these sparse disparities/depth values to the other pixels. The dot matching scores may be used as a basis for interpolation weights when interpolating depths for pixels between the dots.

In practice, interpolation also may factor in edges, e.g., include edge-aware interpolation, because substantial depth changes may occur on adjacent pixels when an object's edge is encountered. Color changes in an RGB image are often indicative of an edge, as are intensity changes in an IR image. If an RGB and/or a clean IR (no dot) view of the scene is available at a calibrated position, the sparse depth may be warped to this view and perform an edge-aware interpolation using techniques such as edge-aware push-pull interpolation or using bilateral filtering. Note that clean IR may be obtained using a notch filter that removes the dots in a captured IR image (and possibly uses a different frequency IR source that illuminates the whole scene in general to provide sufficient IR).

Note that the weights for confidence scores and/or edges can be learned from training data. In this way, for example one confidence score that is double another confidence score need not necessarily be given double weight, but may be some other factor.

Some of the techniques described herein may be applied to a single camera with a known projector pattern. For example, dot based enumeration with the above-described trinocular enumeration already deals with missing pixels, and thus while likely not as accurate as three- (or more) way matching, the same processes apply, such as if a camera fails. Further, as can be readily appreciated, if a system is designed with only a single camera, the match pair structure and FIG. 9 may be modified for a single image, e.g., by removing the right image fields and the right image intermediate iteration.

Similarly, additional fields may be added to the data structure and additional intermediate iterations may be used for more than two cameras. For example, a studio setup may have more than two cameras, and these may be positioned around the projector rather than in line with it. Steps 904, 916 and 918 of FIG. 9 may be modified for any number of cameras, e.g., to select first camera image (step 904), evaluate whether the last camera image has been processed (step 916) and if not, to select the next camera image (step 918).

Thus, one advantage described herein is that multi-view matching is performed, as this reduces the probability of false correspondence and in addition reduces the number of neighboring points needed to support or verify a match. Further, regions that are in shadow in one camera or the other can still be matched to the expected dot position (although with lower reliability). Indeed, the same matching algorithm may be modified/extended to perform matching using the projector and a single camera, or to perform matching using the projector pattern and more than two cameras.

Via calibration, any random or known dot pattern projected onto the scene may be used, including a static dot pattern. This is in contrast to solutions that use dynamic structured light that needs a complicated projector with fast switching and precise control.

Further, a multi-view stereo solution as described herein improves the estimated depth in practice. The matching need only occur at dots and not at every pixel, which is far more efficient. Also, because dot locations may be estimated to sub-pixel precision, match dots that are only fairly close in terms of epipolar geometry and obtain sub-pixel disparity estimates may be matched. Lastly the developed system is robust to failure of cameras within a multi-view setup, with good quality depth estimated even with a single camera viewing the projected dot pattern.

One or more aspects are directed towards a projector that projects a light pattern of dots towards a scene, in which the light pattern is known for the projector and maintained as projected dot pattern data representative of dot positions at different depths. A plurality of cameras, (e.g., a left camera and a right camera), each fixed relative to the projector, capture synchronized images of the scene from different perspectives. A depth estimator determines dot locations for captured dots in each image and computes a set of confidence scores corresponding to different depths for each dot location in each image, in which each confidence score is based upon the projected dot pattern data and a matching relationship with the dot location in each synchronized image. The depth estimator further estimates a depth at each dot location based upon the confidence scores. Each dot location may correspond to a sub-pixel location.

A confidence score may be based upon a number of matching neighbors between a dot location and the projected dot pattern data, and/or based upon a vector that represents the captured dot's location and a set of pattern vectors representing the projected dot pattern data at different depths. A vector that represents the captured dot's location may comprise a bit vector representing a neighborhood surrounding the captured dot location, and the set of pattern vectors may comprise bit vectors representing a neighborhood surrounding the projected dot position at different depths. The set of confidence scores may be based upon a closeness of the bit vector representing the neighborhood surrounding the captured dot location to the set of bit vectors representing the neighborhood surrounding the projected dot position at the different depths.

The depth estimator may remove at least one dot based upon statistical information. The depth estimator may further for conflicting depths for a particular pixel, and to select one depth based upon confidence scores for the pixel when conflicting depths are detected.

The depth estimator may interpolate depth values for pixels in between the dot locations. The interpolation may be based on the confidence scores, and/or on edge detection.

One or more aspects are directed towards processing an image to determine dot locations within the image, in which the dot locations are at a sub-pixel resolution. Depth data is computed for each dot location, including accessing known projector pattern data at different depths to determine a confidence score at each depth based upon matching dot location data with the projector pattern data at that depth. A depth value is estimated based upon the confidence scores for the dot sub-pixel location associated with that pixel. For pixels that are in between pixels associated with the depth values, interpolation is used to find depth values. The interpolating of the depth values may use weighted interpolation based on the confidence scores for the dot sub-pixel locations associated with the pixels being used in an interpolation operation.

The dot locations may be contained as data within a compressed data structure. This is accomplished by compressing the data to eliminate at least some pixel locations that do not have a dot in a sub-pixel associated with a pixel location.

Computing the depth data for each dot location at different depths may comprise determining left confidence scores for a left image dot and determining right confidence scores for a right image dot. Determining the depth value may comprise selecting a depth corresponding to a highest confidence, including evaluating the left and right confidence scores for each depth individually and when combined together.

Computing the depth data based upon matching the dot location data with the projector pattern data may comprise evaluating neighbor locations with respect to whether each neighbor location contains a dot. Computing the depth data may comprise computing a vector representative of the dot location and a neighborhood surrounding the dot location.

One or more aspects are directed towards estimating depth data for each of a plurality of pixels, including processing at least two synchronized images that each capture a scene illuminated with projected dots to determine dot locations in the images, and for each dot location in each image, determining confidence scores that represent how well dot-related data match known projected dot pattern data at different depths. The confidence scores may be used to estimate the depth data.

Also described herein is generating a depth map, including using the depth data to estimate pixel depth values at pixels corresponding to the dot locations, and using the pixel depth values and confidence scores to interpolate values for pixels in between the dot locations. Further described is calibrating the known projected dot pattern data, including determining dot pattern positions at different depths, and maintaining the known projected dot pattern data in at least one data structure.

### Example Operating Environment

It can be readily appreciated that the above-described implementation and its alternatives may be implemented on any suitable computing device, including a gaming system, personal computer, tablet, DVR, set-top box, smartphone and/or the like. Combinations of such devices are also feasible when multiple such devices are linked together. For purposes of description, a gaming (including media) system is described as one exemplary operating environment hereinafter.

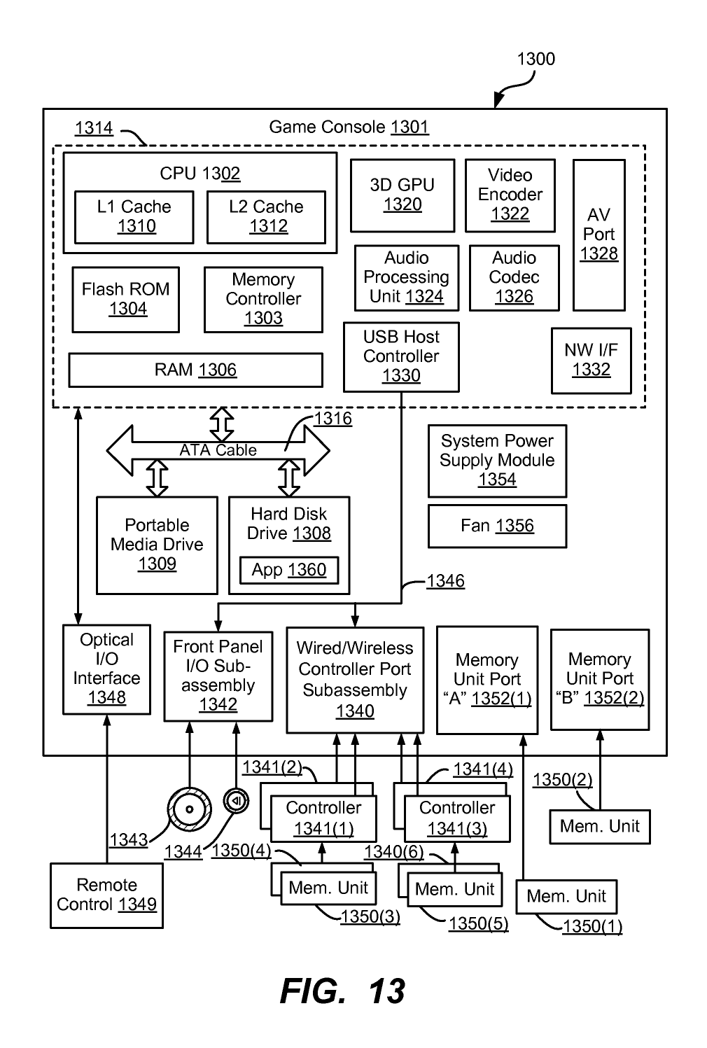

FIG. 13 is a functional block diagram of an example gaming and media system 1300 and shows functional components in more detail. Console 1301 has a central processing unit (CPU) 1302, and a memory controller 1303 that facilitates processor access to various types of memory, including a flash Read Only Memory (ROM) 1304, a Random Access Memory (RAM) 1306, a hard disk drive 1308, and portable media drive 1309. In one implementation, the CPU 1302 includes a level 1 cache 1310, and a level 2 cache 1312 to temporarily store data and hence reduce the number of memory access cycles made to the hard drive, thereby improving processing speed and throughput.

The CPU 1302, the memory controller 1303, and various memory devices are interconnected via one or more buses (not shown). The details of the bus that is used in this implementation are not particularly relevant to understanding the subject matter of interest being discussed herein. However, it will be understood that such a bus may include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, the CPU 1302, the memory controller 1303, the ROM 1304, and the RAM 1306 are integrated onto a common module 1314. In this implementation, the ROM 1304 is configured as a flash ROM that is connected to the memory controller 1303 via a Peripheral Component Interconnect (PCI) bus or the like and a ROM bus or the like (neither of which are shown). The RAM 1306 may be configured as multiple Double Data Rate Synchronous Dynamic RAM (DDR SDRAM) modules that are independently controlled by the memory controller 1303 via separate buses (not shown). The hard disk drive 1308 and the portable media drive 1309 are shown connected to the memory controller 1303 via the PCI bus and an AT Attachment (ATA) bus 1316. However, in other implementations, dedicated data bus structures of different types can also be applied in the alternative.

A three-dimensional graphics processing unit 1320 and a video encoder 1322 form a video processing pipeline for high speed and high resolution (e.g., High Definition) graphics processing. Data are carried from the graphics processing unit 1320 to the video encoder 1322 via a digital video bus (not shown). An audio processing unit 1324 and an audio codec (coder/decoder) 1326 form a corresponding audio processing pipeline for multi-channel audio processing of various digital audio formats. Audio data are carried between the audio processing unit 1324 and the audio codec 1326 via a communication link (not shown). The video and audio processing pipelines output data to an A/V (audio/video) port 1328 for transmission to a television or other display/speakers. In the illustrated implementation, the video and audio processing components 1320, 1322, 1324, 1326 and 1328 are mounted on the module 1314.

FIG. 13 shows the module 1314 including a USB host controller 1330 and a network interface (NW I/F) 1332, which may include wired and/or wireless components. The USB host controller 1330 is shown in communication with the CPU 1302 and the memory controller 1303 via a bus (e.g., PCI bus) and serves as host for peripheral controllers 1334. The network interface 1332 provides access to a network (e.g., Internet, home network, etc.) and may be any of a wide variety of various wire or wireless interface components including an Ethernet card or interface module, a modem, a Bluetooth module, a cable modem, and the like.

In the example implementation depicted in FIG. 13, the console 1301 includes a controller support subassembly 1340, for supporting four game controllers 1341(1)-1341(4). The controller support subassembly 1340 includes any hardware and software components needed to support wired and/or wireless operation with an external control device, such as for example, a media and game controller. A front panel I/O subassembly 1342 supports the multiple functionalities of a power button 1343, an eject button 1344, as well as any other buttons and any LEDs (light emitting diodes) or other indicators exposed on the outer surface of the console 1301. The subassemblies 1340 and 1342 are in communication with the module 1314 via one or more cable assemblies 1346 or the like. In other implementations, the console 1301 can include additional controller subassemblies. The illustrated implementation also shows an optical I/O interface 1348 that is configured to send and receive signals (e.g., from a remote control 1349) that can be communicated to the module 1314.

Memory units (MUs) 1350(1) and 1350(2) are illustrated as being connectable to MU ports “A” 1352(1) and “B” 1352(2), respectively. Each MU 1350 offers additional storage on which games, game parameters, and other data may be stored. In some implementations, the other data can include one or more of a digital game component, an executable gaming application, an instruction set for expanding a gaming application, and a media file. When inserted into the console 1301, each MU 1350 can be accessed by the memory controller 1303.

A system power supply module 1354 provides power to the components of the gaming system 1300. A fan 1356 cools the circuitry within the console 1301.

An application 1360 comprising machine instructions is typically stored on the hard disk drive 1308. When the console 1301 is powered on, various portions of the application 1360 are loaded into the RAM 1306, and/or the caches 1310 and 1312, for execution on the CPU 1302. In general, the application 1360 can include one or more program modules for performing various display functions, such as controlling dialog screens for presentation on a display (e.g., high definition monitor), controlling transactions based on user inputs and controlling data transmission and reception between the console 1301 and externally connected devices.

The gaming system 1300 may be operated as a standalone system by connecting the system to high definition monitor, a television, a video projector, or other display device. In this standalone mode, the gaming system 1300 enables one or more players to play games, or enjoy digital media, e.g., by watching movies, or listening to music. However, with the integration of broadband connectivity made available through the network interface 1332, gaming system 1300 may further be operated as a participating component in a larger network gaming community or system.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system comprising:
a projector that projects a light pattern of dots towards a scene, in which the light pattern is known for the projector and maintained as projected dot pattern data representative of dot positions at different depths;
a plurality of cameras, the cameras each fixed relative to the projector and configured to capture synchronized images of the scene from different perspectives; and
a depth estimator, the depth estimator configured to determine dot locations for captured dots in each image and to compute a set of confidence scores corresponding to different depths for each dot location in each image, each confidence score based upon the projected dot pattern data and a matching relationship with the dot location in each synchronized image, the depth estimator further configured to estimate a depth at each dot location based upon the confidence scores.

2. The system of claim 1 wherein each dot location corresponds to a sub-pixel location.

3. The system of claim 1 wherein each confidence score is based upon a number of matching neighbors between a dot location and the projected dot pattern data.

4. The system of claim 1 wherein each confidence score is based upon a vector that represents the captured dot's location and a set of pattern vectors representing the projected dot pattern data at different depths.

5. The system of claim 4 wherein the vector that represents the captured dot's location comprises a bit vector representing a neighborhood surrounding the captured dot location, wherein the set of pattern vectors comprises bit vectors representing a neighborhood surrounding the projected dot position at different depths, and wherein the set of confidence scores is based upon a closeness of the bit vector representing the neighborhood surrounding the captured dot location to the set of bit vectors representing the neighborhood surrounding the projected dot position at the different depths.

6. The system of claim 1 wherein the depth estimator is further configured to remove at least one dot based upon statistical information.

7. The system of claim 1 wherein the depth estimator is further configured to check for conflicting depths for a particular pixel, and to select one depth based upon confidence scores for the pixel when conflicting depths are detected.

8. The system of claim 1 wherein the depth estimator is further configured to interpolate depth values for pixels in between the dot locations.

9. The system of claim 8 wherein the depth estimator interpolates the depth values based at least in part on at least some of the confidence scores.

10. The system of claim 8 wherein the depth estimator interpolates the depth values based at least in part on edge detection.

11. The system of claim 1 wherein the plurality of cameras comprises a left camera and a right camera.

12. A machine-implemented method comprising:
processing an image to determine dot locations within an image, in which the dot locations are at a sub-pixel resolution;
computing depth data for each dot location, including accessing known projector pattern data at different depths to determine a confidence score at each depth based upon matching dot location data with the projector pattern data at that depth;
determining, for each pixel of a plurality of pixels, a depth value based upon the confidence scores for the dot sub-pixel location associated with that pixel; and
interpolating depth values for pixels that are in between pixels associated with the depth values.

13. The method of claim 12 wherein interpolating the depth values comprises using weighted interpolation based at least in part on the confidence scores for the dot sub-pixel locations associated with the pixels being used in an interpolation operation.

14. The method of claim 12 further comprising, maintaining the dot locations as data within a compressed data structure, including compressing the data to eliminate at least some pixel locations that do not have a dot in a sub-pixel associated with a pixel location.

15. The method of claim 12 wherein computing the depth data for each dot location at different depths comprises determining left confidence scores for a left image dot and determining right confidence scores for a right image dot.

16. The method of claim 15 wherein determining the depth value comprises selecting a depth corresponding to a highest confidence, including evaluating the left and right confidence scores for each depth individually and when combined together.

17. The method of claim 12 wherein computing the depth data based upon matching the dot location data with the projector pattern data comprises evaluating neighbor locations with respect to whether each neighbor location contains a dot, or computing a vector representative of the dot location and a neighborhood surrounding the dot location.

18. One or more machine-readable devices or machine logic having executable instructions, which when executed perform steps, comprising, estimating depth data for each of a plurality of pixels, including processing at least two synchronized images that each capture a scene illuminated with projected dots to determine dot locations in the images, and for each dot location in each image, determining confidence scores that represent how well dot-related data match known projected dot pattern data at different depths, and using the confidence scores to estimate the depth data.

19. The one or more machine-readable devices or machine logic of claim 18 having further executable instructions comprising generating a depth map including using the depth data to estimate pixel depth values at pixels corresponding to the dot locations, and using the pixel depth values and confidence scores to interpolate values for pixels in between the dot locations.

20. The one or more machine-readable devices or machine logic of claim 18 having further executable instructions comprising, calibrating the known projected dot pattern data, including determining dot pattern positions at different depths, and maintaining the known projected dot pattern data in at least one data structure.
